(19) United States
(12) Patent Application Publication
(10) Pub. No.: US 2026/0259342 A1
(43) Pub. Date: Sep. 3, 2026

(54) DIPOLE BEAMFORMING STACK

(71) Applicant: Schlumberger Technology Corporation, Sugar Land, TX (US)

(72) Inventors: Nobuyasu Hirabayashi, Sugar Land, TX (US); Manish Lal Khaitan, Crawley (GB); Carlos Alejandro Arenas Arenas, Santa Cruz de la Sierra (BO)

(21) Appl. No.: 19/551,850

(22) Filed: Feb. 27, 2026

Related U.S. Application Data
(60) Provisional application No. 63/765,247, filed on Feb. 28, 2025.

(51) Int. Cl. G01V 1/46

(52) U.S. Cl. CPC G01V 1/46; G01V 2210/1429

(57) ABSTRACT

A method for processing sonic waveforms may include an improved beamforming stacking method, wherein the improved beamforming stacking method comprises using different combinations of receivers by normalizing amplitudes of the waveforms given by subtraction of waveforms of a pair of receivers by receiver distance. An azimuth computation method is further disclosed for use in combination with the improved beamforming stacking.

### CROSS-REFERENCE TO RELATED APPLICATIONS

The present application claims priority to and the benefit of U.S. Provisional Patent Application Ser. No. 63/765,247 titled “IMPROVED DIPOLE BEAMFORMING STACK” filed Feb. 28, 2025, the disclosure of which is incorporated herein by reference in its entirety.

### BACKGROUND

Sonic imaging, which is also known as the borehole acoustic reflection surveys (BARS), uses a sonic logging tool in a fluid-filled borehole to image geologic structures. Signals from monopole and dipole sources are reflected from the geologic interfaces and recorded by arrays of receivers of the same tool. Because the amplitudes of the event signals are very weak, the event signals are often difficult to extract. To enhance the weak event signals, beamforming techniques have been developed, which stack the waveforms of azimuthally spaced receivers of the tool for given azimuthal directions.

### SUMMARY

In some aspects, the techniques described herein relate to a method. A sonic signal processing system activates a sonic tool and emits a signal into a geological formation. The sonic signal processing system receives a plurality of reflected signals at the sonic tool. Each of the plurality of reflected signals is received at a respective receiver of a plurality of receivers on the sonic tool. Each of the plurality of reflected signals has an associated waveform of a plurality of waveforms. The sonic signal processing system generates a plurality of stacked waveforms, each stacked waveform of the plurality of stacked waveforms is associated with a virtual receiver of a plurality of virtual receivers. Generating each stacked waveform of the plurality of stacked waveforms includes subtracting a first waveform of the plurality of waveforms from a second waveform of the plurality of waveforms, resulting in a subtracted waveform. The first waveform is associated with a first receiver of the plurality of receivers and the second waveform is associated with a second receiver of the plurality of receivers. Generating the stacked waveforms further includes dividing the subtracted waveform by a distance difference between a first distance for the first receiver and a second distance for the second receiver.

In some aspects, the techniques described herein relate to a method. A sonic signal processing system identifies a plurality of virtual receivers for a sonic tool. The sonic tool includes a plurality of receivers arranged around a housing. Using a plurality of waveforms generated from a plurality of sonic signals received at the plurality of receivers, the sonic signal processing system generates a plurality of stacked waveforms by normalizing the plurality of waveforms based on a distance of the plurality of receivers. Each of the plurality of stacked waveforms is associated with an associated virtual receiver of the plurality of virtual receivers.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 is a representation of a conveyance system, according to at least one embodiment of the present disclosure.

FIG. 2 is a schematic cutaway view of a sonic survey system, according to at least one embodiment of the present disclosure.

FIG. 3-1 through FIG. 3-3 are schematic representations of properties of amplitudes constructed by a pair of receivers for an incident sonic signal, according to at least one embodiment of the present disclosure.

FIG. 4-1 and FIG. 4-2 are representations of a downhole tool, according to at least one embodiment of the present disclosure.

FIG. 5 is a flowchart of a method for generating a normalized signal at a virtual receiver, according to at least one embodiment of the present disclosure.

FIG. 6 is a flowchart of a method for generating a normalized signal at a virtual receiver, according to at least one embodiment of the present disclosure.

FIG. 7 is a representation of a computing system, according to at least one embodiment of the present disclosure.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

This disclosure generally relates to devices, systems, and methods for sonic sensor interpretation in a downhole tool. For example, the emission of a sonic pulse from a sonic pulse may cause pressure waves to emanate from the transmitter (e.g., monopole transmitter, dipole transmitter), into a fluid surrounding the sonic sensor, and into the surrounding environment. The pressure waves may be propagated through the surrounding environment back to the sonic sensor. The sonic sensor may include multiple receivers spaced azimuthally around the sonic sensor. The receivers may measure the time-series waveform that are the result of the propagated sonic pulse. The time-series waveforms measured by the receivers may be used to identify certain characteristics of the surrounding environment. For example, the time-series waveforms may be used to determine the condition of the cement between a casing and the formation, the condition of the casing, the condition of the formation, and so forth.

Embodiments of the present disclosure discuss the use of an acoustic sensor. Unless explicitly stated otherwise, the discussion of sonic sensors, signals, or measurements refer to the use of measurements in the sonic range, including signals between 20 Hz and 30 kHz. However, it should be understood that the techniques of the present disclosure may be applied to ultrasonic signals (e.g., at frequencies of greater than 30 kHz) and sensors.

Embodiments of the present disclosure may discuss the time-series waveforms or other waveforms as “pressure profiles” or “waveforms.” It should be understood that the techniques of the present disclosure may be applied to other time-series waveforms than pressure profiles. For example, the sensors of the present disclosure may include piezoelectric elements, voltage measurement elements, hydrophone transducers, any other physical sensors, and combinations thereof. Thus, the “pressure profiles” discussed herein may be interpreted as the waveform or measurement profile of any measurement measured by a sonic sensor.

As will be discussed in further detail below, the present disclosure includes a number of practical applications having features described herein that provide benefits and/or solve problems associated with determining the eccentricity of a tubular within a wellbore. Some example benefits are discussed herein in connection with various features and functionalities provided by a sonic evaluation system implemented on one or more computing devices. It will be appreciated that benefits explicitly discussed in connection with one or more embodiments described herein are provided by way of example and are not intended to be an exhaustive list of all possible benefits of the sonic evaluation system.

For instance, the present disclosure relates to beamforming processing used to construct waveforms for fixed borehole azimuths. Resolution of dipole beamforming stack may be improved by using different combinations of receivers and normalizing the amplitudes of the waveforms. The amplitudes are normalized by subtraction of waveforms of a pair of receivers by receiver distance. The azimuth computation method using the trigonometric addition theorem which is combined with the method of Hirabayashi et al. (2024) and U.S. Ser. No. 18/928,397 is also shown, the entirety of which is incorporated herein by reference. This may facilitate increased accuracy in the determination of the location and/or angle of reflectors in formation using the waveforms.

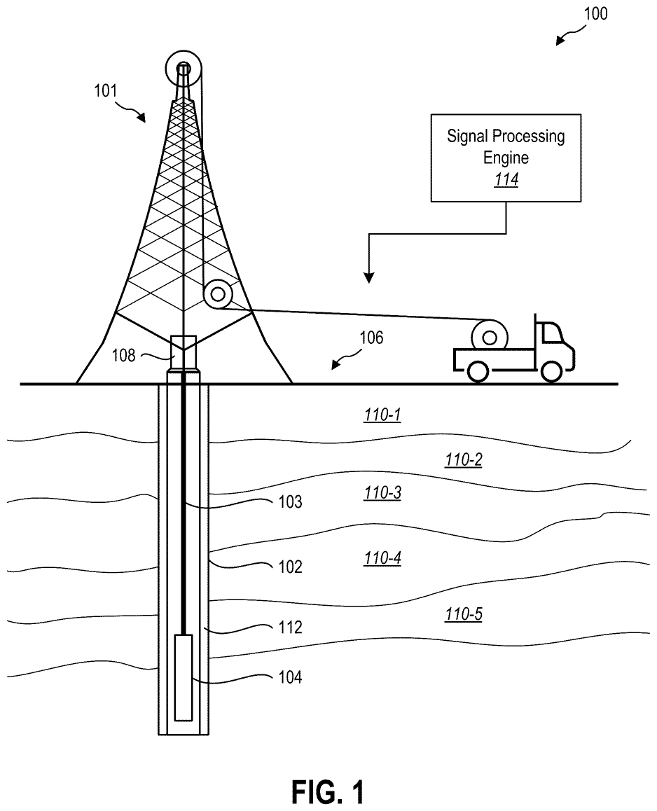

Additional details will now be provided regarding systems described herein in relation to illustrative figures portraying example implementations. For example, FIG. 1 shows one example of a conveyance system 100 for performing a conveyance operation within a wellbore 102, with which a survey may be performed to collect survey data along the wellbore length of the wellbore 102. The conveyance system 100 includes a rig, mast, or derrick 101 used to support a conveyance line 103 (e.g., wireline line or coiled tubing line) at a surface 106. The conveyance line 103 may be suspended, inserted into, or otherwise positioned within the wellbore 102. For instance, the conveyance line 103 may pass through a wellhead 108. The wellhead 108 may provide a structural, pressure, and/or fluid barrier between the wellbore and the surface 106. For instance, the wellhead 108 may contain wellbore fluids within the wellbore 102. In some embodiments, surface equipment of the conveyance system 100 includes an injector head for conveying the conveyance line 103 within the wellbore. For example, an injector head may include one or more (e.g., hydraulic) drives, chain assemblies, grip assemblies, or other components for providing a tractive effort for running and/or retrieving the conveyance line 103 into and/or from the wellbore 102.

The wellbore 102 may extend through a subsurface and may traverse various formations, layers, strata, or other subterranean features (collectively formations 110). The wellbore 102 may be a completed (e.g., fully drilled or fully formed) wellbore, or may be a wellbore at any intermediate stage of completion. The wellbore 102 is depicted as extending substantially straight or vertical into the ground, however, the wellbore 102 may be formed in accordance with any trajectory. For example, the wellbore 102 can include one or more bends, doglegs, inclinations, etc., such that the wellbore 102 may exhibit any level of deviation or tortuosity, including in 3-dimensional space.

The conveyance line 103 is connected to a downhole tool 104 for supporting or positioning the downhole tool 104 in the wellbore 102. The downhole tool 104 may be a logging tool, a completion tool, a production tool, or any other tool used for performing any downhole operation, such as for imaging or otherwise measuring characteristics of the wellbore 102 or subsurface, performing a perforation, setting a plug, retrieving lost or stuck equipment, isolating wellbore sections, testing wellbore integrity, sampling fluids, wellbore cleaning, wellbore repair, opening or closing valves, stimulation (e.g., fracking), circulating fluid, downhole communication, or any other tool for performing any other downhole function.

In accordance with at least one embodiment of the present disclosure, the downhole tool 104 may include a survey tool. The survey tool may include one or more sensors. Each sensor may be associated with one or more survey data logs. For example, a sensor may perform measurements that may be collected as the survey data log. The sensor measurements in the survey data logs may be correlated with a depth or location in the wellbore 102. This may allow the operator to associate the survey data log information with a particular depth or location.

The wellbore 102 may extend through multiple formations 110. For example, in the embodiment shown, the wellbore 102 extends through a first formation 110-1, a second formation 110-2, a third formation 110-3, a fourth formation 110-4, and a fifth formation 110-5. Based on the geology of the area, the formations 110 may have different lithology. The wellbore 102 may include a casing 112, or another or multiple tubulars including production tubing, in addition to the casing. The casing 112 may include a barrier between the wellbore 102 and the formation 110. For example, the casing 112 may include a steel tubing that is inserted into the wellbore 102. The casing 112 may be secured in the wellbore 102 via a cementing system. For example, the annular space between the casing 112 and the formation 110 may be grouted or filled with a cement, grout, or other flowable material that may be flowed into the annular space and harden after a curing period.

While FIG. 1 is illustrated as an intervention system in a pre-drilled wellbore, it should be understood that the techniques of the present disclosure may be applied to any sonic tool used in any subsurface environment and used to characterize the formation 110. For example, the downhole tool 104 may be located at a bottomhole assembly (BHA) of a drilling assembly. The downhole tool 104 may be located at a logging while drilling (LWD) or measuring while drilling (MWD) tool of a BHA that is used to advance a wellbore, install a dogleg, perform reaming operations, or other downhole drilling system. In some embodiments, the downhole tool 104 may be located in a completion installation system, such as a casing installation system, perforation system, or other downhole system.

In accordance with at least one embodiment of the present disclosure, the downhole tool 104 may include a sonic sensor, or a single or a set of multiple sonic transmitters and a set of sonic receivers. The sonic sensor may be transported into the wellbore 102. The sonic transmitter may emit sonic pulses. The sonic pulses may propagate and reflect from various components of the subsurface, such as the casing 112, the wellbore wall, unconformities between the strata of the formation 110 (e.g., the contact between the first formation 110-1 and the second formation 110-2, between the second formation 110-2 and the third formation 110-3, between the third formation 110-3 and the fourth formation 110-4, between the fourth formation 110-4 and the fifth formation 110-5), faults, joints, or other reflectors. The sonic pulses may propagate to the sonic receiver located at another location of the downhole tool 104. The downhole tool 104 may utilize the waveform of the reflected sonic pulse to characterize the subsurface. For example, the sonic sensor may utilize the waveform to identify the relative location and/or orientation of the reflectors.

In accordance with at least one embodiment of the present disclosure, a sonic measurement system may include a signal processing engine 114. The signal processing engine 114 may receive the reflected sonic signals captured by receivers on the downhole tool 104. For example, the receivers may include pressure receivers, and the downhole tool 104 may measure the pressure profile of the fluid in the wellbore 102. The signal processing engine 114 may receive the pressure profile as measured at the downhole tool 104 and normalize the signals at a particular orientation based on the measurements from multiple receivers. For example, as discussed herein, the signal processing engine 114 may generate a normalized measurement for a receiver pair. The normalized measurement may include a difference of the waveforms that is divided by the receiver distance. This normalized measurement may facilitate characterization of the formation with increased resolution, including identification of the location and/or orientation of the reflector.

In some embodiments, the signal processing engine 114 may receive the survey measurements from the downhole tool 104 at the surface. For example, the downhole tool 104 may include local storage that may store the survey measurements collected at the downhole tool 104. When the downhole tool 104 is returned to the surface location, the local memory on the downhole tool 104 may be accessed and the survey measurements collected. The signal processing engine 114 may identify the eccentricity of the pressure profile using the measurements retrieved from the downhole tool 104 at the surface. This may facilitate improved analysis of the survey measurements at the surface. In this manner, the sonic measurement system may generate an improved analysis of the subsurface formation surrounding the wellbore 102.

In some embodiments, the signal processing engine 114 may characterize the subsurface formation while the downhole tool 104 is still downhole in the wellbore 102. For example, the conveyance line 103 may include a communication mechanism, such as a wired communication system. The downhole tool 104 may transmit the survey measurements to the surface location via the conveyance line 103. The signal processing engine 114 may identify the characterize the formation using the received survey measurements. The signal processing engine 114 may then transmit the reflectors back to the downhole tool 104 via the conveyance line 103. Based on the location of the reflectors, the downhole tool 104 and/or the sonic measurement system at the surface may adjust one or more tool settings of the downhole tool 104. For example, the downhole tool 104 may use the location and/or orientation of the reflector to adjust the frequency and/or magnitude of the dipole, adjust the positioning of the downhole tool 104, adjust a setting of the downhole tool 104, adjust a rotational orientation of the downhole tool 104, or otherwise adjust operation of the downhole tool 104. In this manner, the characterization of the subsurface formation may be used to modify operation of the downhole tool 104 during a downhole survey operation.

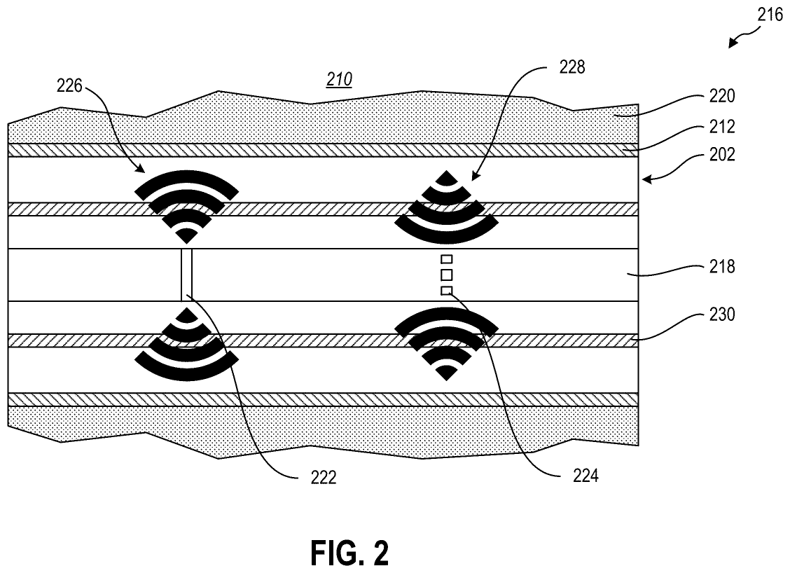

FIG. 2 is a schematic cutaway view of a sonic survey system 216, according to at least one embodiment of the present disclosure. The sonic survey system 216 may include a sonic tool 218 located in a wellbore 202. The wellbore may be lined with a casing 212, and the casing may be cemented or grouted to a formation 210 with a cementing material 220. For example, the cementing material 220 may be flowed into and allowed to cure or harden in an annular space between the casing 212 and the formation 210. A drilling or other fluid may flow or be pumped through the wellbore 202. For example, the fluid may flow through the wellbore 202 around the sonic tool 218 and/or around the tubular 230. The wellbore may contain another tubular 230, such as production tubing, in addition to the casing 212. The annulus between the casing 212 and the tubular 230 may be filled with fluid such as drilling mud, gas such as produced natural gas or injected gas, or solid such as cemented.

The sonic tool 218 may include at least one transmitter 222 and a set of receivers 224. The transmitter 222 may include any type of transmitter. For example, the transmitter 222 may include a monopole transmitter, a dipole transmitter, or any other type of transmitter. The transmitter 222 may be activated to vibrate at a sonic frequency (e.g., greater than 20 kHz). For example, the transmitter 222 may be activated to vibrate for a period of time at the sonic frequency to generate a sonic pulse 226. The sonic pulse 226 may be emitted from the transmitter 222 into the area surrounding the sonic tool 218. For example, the sonic pulse 226 may be emitted into the fluid in the wellbore 202, travel to the casing 212, pass through the casing 212 to the cementing material 220, and through the cementing material 220 to the formation 210. The sonic pulse 226 may be reflected off one or more reflectors in the formation 210.

The sonic pulse 226 may be propagated at or in one or more of these areas (e.g., the formation 210 and reflectors in the formation 210) to generate a pulse 228. The pulse 228 may travel to the receivers 224. The receivers may measure the pulse 228. For example, the receivers may include pressure sensors, which may measure the variations in the fluid pressure of the fluid surrounding the sonic tool 218 at the receivers 224 caused by the sonic pulse 226 and the reflected pulse 228.

The characteristics of the pulse 228 may be analyzed to determine properties of the sonic survey system 216 (e.g., the location and/or orientation of reflectors in the formation 210). For example, the waveform of the pulse 228, including the detected timing, the amplitude, the shape, the pattern, and other variabilities in the waveform of the pulse 228, may be used to identify characteristics of the formation, including the location and/or orientation of reflectors.

The receivers 224 may include multiple receivers spaced azimuthally in the sonic tool 218. For example, the receivers 224 may be spaced azimuthally inside the tool 218. In this manner, the sonic tool 218 may measure the pressure at various azimuthal locations around the sonic tool 218. This may facilitate the identification of a pressure profile at the receivers 224. The pressure profile may be a representation of the fluid pressure at different azimuthal locations around the sonic tool 218, as measured by the receivers 224. For example, two or more of the receivers 224 may measure a different fluid pressure at the same measurement time. The different fluid pressures may be analyzed, mapped, graphed, or otherwise processed to identify the pressure profile at the measurement time.

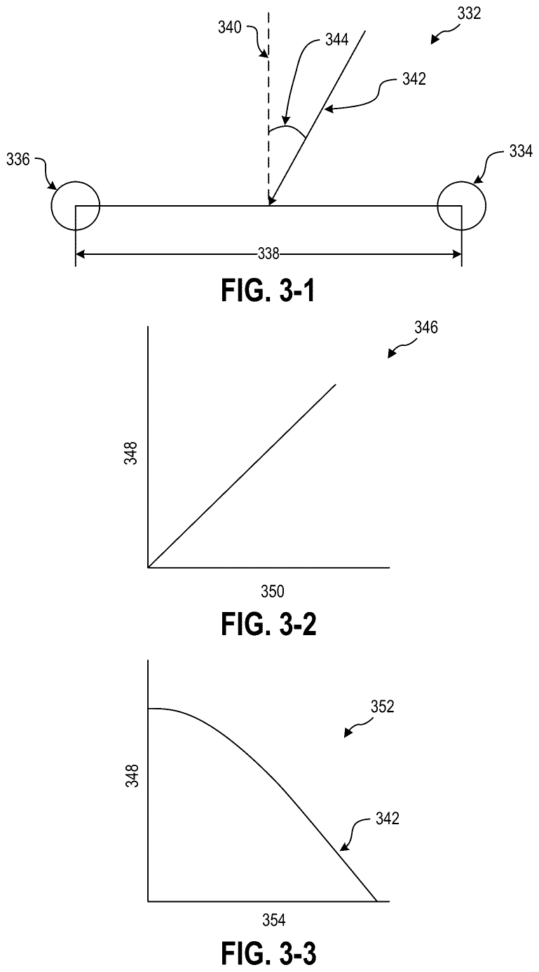

FIG. 3-1 through FIG. 3-3 show a schematic illustration of properties of amplitudes constructed by a pair of receivers for an incident sonic signal 342, according to at least one embodiment of the present disclosure. The sonic signal 342 may be any sonic signal, such as an SH-wave. FIG. 3-1 is a schematic representation of a receiver pair 332 of a sonic tool. The receiver pair 332 includes a first receiver 334 and a second receiver 336. The first receiver 334 is separated from the second receiver 336 by a separation distance 338. A measurement axis 340 may be located between the first receiver 334 and the second receiver 336. For example, in the embodiment shown, the measurement axis 340 is located halfway between the first receiver 334 and the second receiver 336, although the techniques of the present disclosure may be applied to a measurement axis 340 located any distance between the first receiver 334 and the second receiver 336.

In accordance with at least one embodiment of the present disclosure, the first receiver 334 and the second receiver 336 may include sonic receivers that may receive a sonic signal 342. The sonic signal 342 may be received at the first receiver 334 and the second receiver 336. In accordance with at least one embodiment of the present disclosure, a composite signal may be determined based on a combination of the sonic signal 342 received at the first receiver 334 and the second receiver 336. For example, the composite signal may be representative of the sonic signal 342 that would have been measured at the measurement axis 340.

The sonic signals received at the first receiver 334 and the second receiver 336 may be similar. Subtraction of one of the signals from the first receiver 334 and the second receiver 336 and processing of the subtracted signal may facilitate increased resolution of the resulting image. For example, consider a set of receivers having spaced around a housing with a radius R. FIG. 3-2 is a representation of an amplitude plot 346 with amplitude 348 on the y-axis and distance 350 on the x-axis. As illustrated in FIG. 3-2, when the radius of azimuthal receiver positions is small, the amplitude may have a linear relationship with the receiver distance.

In some embodiments, the amplitude is the cosine function of the incident angle 344. For example, the sonic signal 342 is incident to the first receiver 334, the second receiver 336, and/or the measurement axis 340 with an incident angle 344. For example, FIG. 3-3 is a schematic representation of an angle plot 352 illustrating amplitude 348 on the y-axis and incident angle 354 on the x-axis. As may be seen, the amplitude of the sonic signal 342 may vary with the incident angle 354 according to the cosine of the incident angle 344.

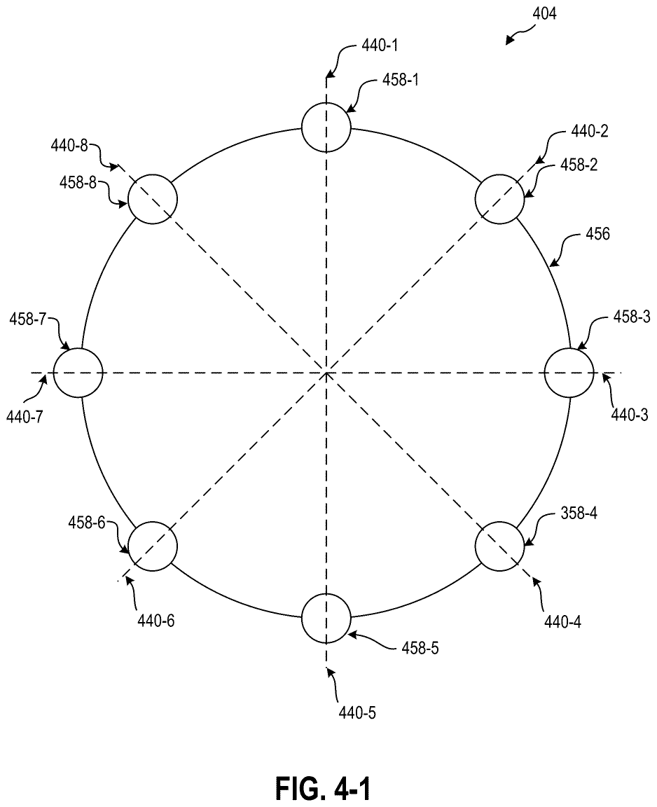

FIG. 4-1 is a schematic representation of a downhole tool 404, according to at least one embodiment of the present disclosure. The downhole tool 404 may include multiple receivers (collectively 458) arranged along measurement axes (collectively 440). In the embodiment shown, the downhole tool 404 includes eight receivers 458 (with eight measurement axes 440) arranged evenly around a housing 456 of the downhole tool 404. The receivers 458 may include a first receiver 458-1 at a first measurement axis 440-1, a second receiver 458-2 at a second measurement axis 440-2, a third receiver 458-3 at a third measurement axis 440-3, a fourth receiver 458-4 at a fourth measurement axis 440-4, a fifth receiver 458-5 at a fifth measurement axis 440-5, a sixth receiver 458-6 at a sixth measurement axis 440-6, a seventh receiver 458-7 at a seventh measurement axis 440-7, and an eighth receiver 458-8 at an eighth measurement axis 440-8. The measurement axes 440 may be directional, with the first measurement axis 440-1 being 180° opposite the fifth measurement axis 440-5, the second measurement axis 440-2 being 180° opposite the sixth measurement axis 440-6, the third measurement axis 440-3 being 180° opposite the seventh measurement axis 440-7, and the fourth measurement axis 440-4 being 180° opposite the eighth measurement axis 440-8. Further, adjacent measurement axes 440 may be offset by 45°. The receivers 458 may each receive a reflected signal, and an associated waveform may be generated using the reflected signal.

In accordance with at least one embodiment of the present disclosure, the amplitude of a virtual receiver may be normalized by receiver distance. For example, a virtual receiver may be located between two opposing receivers, and the amplitude of the waveform at the virtual receiver may be normalized between the two receivers. The amplitude for each receiver pair in a common receiver station may be combined to generate a stacked waveform. In accordance with at least one embodiment of the present disclosure, to generate the stacked waveform at a receiver 458 between two adjacent receivers, the amplitude of a receiver pair may be normalized according to:

$${w}_{2 n - 1}^{′} = {\sum }_{k = 1}^{N / 4} {a}_{k} \frac{{w}_{n + k} - {w}_{n - 1 - k}}{\vert {r}_{n + k} - {r}_{n - 1 - k} \vert} \qquad Eq . 1$$

where wᵢ is a waveform at position i surrounding the housing 456 (where 1≤i≤N), w′ is the normalized waveform (e.g., stacked waveform), N is the number of receivers, n is the target virtual receiver (1≤n≤N), a is a constant, r is the receiver distance, and k is a receiver pair number. The wₙ₊ₖ−wₙ₋₁₋ₖ component of Eq. 1 (and the subsequent derivative equations) may be considered the subtracted waveform, and the |rₙ₊ₖ−rₙ₋₁₋ₖ| component of Eq. 1 (and the subsequent derivative equations) may be considered the distance difference. In some embodiments, the distance difference may be an absolute value of the distance difference. In the embodiment of FIG. 4-1, the virtual receiver may be coincident with a third receiver between two adjacent receivers. For example, the virtual receiver of FIG. 4-1 may be coincident with the first receiver 458-1.
In the embodiment shown in FIG. 4-1, w′ may be determined for each of the measurement axes. For example, w′ may be determined for the first measurement axis 440-1, with n=1, according to:

$$k = 1 , {w}_{1 , 1}^{′} = {a}_{1} \frac{{w}_{2} - {w}_{0}}{\vert {r}_{2} - {r}_{0} \vert} \qquad Eq . 2.1$$

$$k = 2 , {w}_{1 , 2}^{′} = {a}_{2} \frac{{w}_{3} - {w}_{- 1}}{\vert {r}_{3} - {r}_{- 1} \vert} \qquad Eq . 2.2$$

$${w}_{1}^{′} = {w}_{1 , 1}^{′} + {w}_{1 , 2}^{′} \qquad Eq . 2.3$$

where w₀ is the waveform measured at the eighth receiver 458-8 and w₋₁ is the waveform measured at the seventh receiver 458-7 (e.g., n+1 moves the receiver count clockwise around the housing 456, n-1 moves the receiver count counter-clockwise around the housing 456). In the embodiment shown, w₃ and w₋₁ may be diametrically opposed (e.g., the third measurement axis 440-3 may be parallel to the seventh measurement axis 440-7). Eq. 2.1 may result in a first stacked waveform part w′_{1,1} and Eq. 2.2 may result in a second stacked waveform part w′_{1,2}. The stacked waveform parts w′_{1,1} and w′_{1,2} may be summed, resulting in the stacked waveform w′₁. This process may be repeated for n=1 through n=8, resulting in eight stacked waveforms.

In some embodiments, w′ᵢ is the stacked waveform defined at a particular azimuth of measured clockwise from the 440-1// of the first receiver 458-1. θ′ᵢ may be provided by:

$${θ}_{i}^{′} = \frac{1}{N} ( i - 1 ) π \qquad Eq . 3$$

The parameter aₖ may be satisfied by:

$${\sum }_{k = 1}^{N / 4} {a}_{k} = 1 \qquad Eq . 4$$

An example of aₖ for an eight-receiver setup may be provided by:

$${a}_{1} = \frac{\sqrt{2 - \sqrt{2}}}{\sqrt{2}} , \qquad Eq . 5$$

$${a}_{2} = 1.0 - {a}_{1}$$

FIG. 4-2 is a representation of the downhole tool 404 of FIG. 4-1 illustrating multiple offset measurement axes (collectively 441), including a first offset measurement axis 441-1, a second offset measurement axis 441-2, a third offset measurement axis 441-3, a fourth offset measurement axis 441-4, a fifth offset measurement axis 441-5, a sixth offset measurement axis 441-6, a seventh offset measurement axis 441-7, and an eighth offset measurement axis 441-8. As may be seen, the offset measurement axes 441 may be located between adjacent receivers 458. For example, the first offset measurement axis 441-1 is located between the first receiver 458-1 and the eighth receiver 458-8, the second offset measurement axis 441-2 is located between the first receiver 458-1 and the second receiver 458-2, the third offset measurement axis 441-3 is located between the second receiver 458-2 and the third receiver 458-3, the fourth offset measurement axis 441-4 is located between the third receiver 458-3 and the fourth receiver 458-4, the fifth offset measurement axis 441-5 is located between the fourth receiver 458-4 and the fifth receiver 458-5, the sixth offset measurement axis 441-6 is located between the fifth receiver 458-5 and the sixth receiver 458-6, the seventh offset measurement axis 441-7 is located between the sixth receiver 458-6 and the seventh receiver 458-7, and the eighth offset measurement axis 441-8 is located between the seventh receiver 458-7 and the eighth receiver 458-8. Adjacent receivers 458 may be used to generate a composite or stacked waveform for a virtual receiver at the offset measurement axes 441. In the embodiment shown, a virtual receiver quantity of virtual receivers (e.g., at the offset measurement axes 441 and the eight measurement axes 440) may be double a receiver quantity of the receivers.

In accordance with at least one embodiment of the present disclosure, to generate the stacked waveform at a receiver 458 between two adjacent receivers, the amplitude of a receiver pair may be normalized at a virtual receiver according to:

$${w}_{2 n}^{′} = {\sum }_{k = 1}^{N / 4} {b}_{k} \frac{{w}_{n + k} - {w}_{n + 1 - k}}{\vert {r}_{n + k} - {r}_{n + 1 - k} \vert} \qquad Eq . 6$$

where wᵢ is a waveform at a position i, w′ is the normalized waveform (e.g., stacked waveform), N is the number of receivers, n is the target virtual receiver (1≤n≤N), a is a constant, r is the receiver distance, and k is a receiver pair number. The wₙ₊ₖ−wₙ₊₁₋ₖ component of Eq. 1 (and the subsequent derivative equations) may be considered the subtracted waveform, and the |rₙ₊ₖ−rₙ₊₁₋ₖ| component of Eq. 1 (and the subsequent derivative equations) may be considered the distance difference. In some embodiments, the distance difference may be an absolute value of the distance difference.
In the embodiment shown in FIG. 4-2, w′ may be determined for each of the offset measurement axes 441. For example, w′ may be determined for the second offset measurement axis 441-2, with n=1, according to:

$$\begin{matrix}k = 1 , & {w}_{2 , 1}^{′} = {b}_{1} \frac{{w}_{2} - {w}_{1}}{\vert {r}_{2} - {r}_{1} \vert}\end{matrix} \qquad Eq . 7.1$$

$$\begin{matrix}k = 2 , & {w}_{2 , 2}^{′} = {b}_{2} \frac{{w}_{3} - {w}_{0}}{\vert {r}_{3} - {r}_{0} \vert}\end{matrix} \qquad Eq . 7.2$$

$${w}_{2}^{′} = {w}_{2 , 1}^{′} + {w}_{2 , 2}^{′} \qquad Eq . 7.3$$

where w₁ is the waveform measured at the first receiver 458-1, w₂ is waveform measured at the second receiver 458-2, w₃ is waveform measured at the third receiver 458-3, r₁ is the first receiver distance, r₂ is the second receiver distance, and r₃ is the third receiver distance. Eq. 7.1 may result in a first stacked waveform part w′_{2,1} and Eq. 7.2 may result in a second stacked waveform part w′_{2,2}. The stacked waveform parts w′_{1,1} and w′_{1,2} may be summed, resulting in the stacked waveform w′₁. This process may be repeated for n=1 through n=8, resulting in eight stacked waveforms for the eight offset measurement axes 441. The parameter bₖ may be satisfied by:

$${\sum }_{k = 1}^{N / 4} {b}_{k} = 1 \qquad Eq . 8$$

An example of bₖ for an eight-receiver setup may be provided by:

$${b}_{1} = 0 , \qquad Eq . 9$$

$${b}_{2} = 1$$

Performing the normalization according to Eq. 1 and Eq. 6 may facilitate generation of the stacked waveforms in 2N azimuthal directions from N azimuthal receivers. In the example provided in FIG. 4-1 and FIG. 4-2, performing the normalization according to Eq. 1 and Eq. 6 may facilitate the generation of stacked waveforms in 16 directions (e.g., the 8 eight measurement axes 440 and the 8 offset measurement axes 441) from the 8 receivers 458. This may facilitate improved resolution of the resulting image of the formation.

In some embodiments, the signal to noise ratio of the stacked waveforms may be enhanced without the resolution of 180° ambiguities by modifying Eq. 1 according to:

$${w}_{2 n - 1}^{′} = {\sum }_{k = 1}^{\frac{N}{2} - 1} {a}_{k} \frac{{w}_{n + k} - {w}_{n - 1 - k}}{\vert {r}_{n + k} - {r}_{n - 1 - k} \vert} \qquad Eq . 10$$

Eq. 6 may be modified according to:

$${w}_{2 n}^{′} = {\sum }_{k = 1}^{N / 2} {b}_{k} \frac{{w}_{n + k} - {w}_{n + 1 - k}}{\vert {r}_{n + k} - {r}_{n + 1 - k} \vert} \qquad Eq . 11$$

Eq. 10 and Eq. 11 adjusts the range of summations to include an additional pairs of waveforms, thereby improving the quality of the stacked waveform by increasing the number of waveforms used to generate the stacked waveform.

When single-component waveforms are used, such as X- and Y-dipoles, a waveform oriented to a fixed borehole azimuth can be obtained from the stacked waveforms using quadratic interpolation (or Lagrange polynomials).

In accordance with at least one embodiment of the present disclosure, the sensor transmitter may include independent X- and Y-directional sources for dipole measurements. The independent directional sources may be separately acquired and processed. The X- and Y-dipole waveforms may be combined to enhance event signals, reduce processing time, and provide one result from the dipole measurements, thereby improving overall interpretation.

The incorporation of X- and Y-directional dipole sources may be performed by defining two sign functions to adjust the polarities of the waveforms for the X- and Y-dipole sources. The X-directional sign function may be provided by:

$${σ}_{X} ( θ ) = \{ \begin{matrix}1 , 0 < θ < \frac{π}{2} , \frac{3 π}{2} < θ < 2 π , \\ - 1 , \frac{π}{2} < θ < \frac{3 π}{2} , \\ 0 , θ = \frac{π}{2} , \frac{3 π}{2}\end{matrix} \qquad Eq . 12$$

where σ_{X} is the X-directional component. The Y-directional sign function may be provided by:

$${σ}_{y} ( θ ) = \{ \begin{matrix}1 , π < θ < 2 π , \\ - 1 , 0 < θ < π , \\ 0 , θ = 0 , π\end{matrix} \qquad Eq . 13$$

where σ_{Y} is the Y-directional component. The combined waveforms for the X- and Y-dipole sources may be given by:

$${w}_{XY} ( θ ) = {σ}_{X} ( θ - {θ}_{rb} ) {w}_{X} ( θ ) + {σ}_{Y} ( θ - {θ}_{rb} ) {w}_{Y} ( θ ) \qquad Eq . 14$$

where θ_{rb} is the relative-bearing of the tool, w_{X}(θ) is the waveform for the X-dipole and w_{Y}(θ) is the waveforms for the Y-dipole sources, that are stacked according to Eq. 1 through Eq. 11 as discussed above, and w_{XY} (θ) is the combined waveform including the X- and Y-dipole sources.

When the X- and Y-dipole waveforms are combined, w′ᵢ of the X- and Y-dipole waveforms are added after modifying polarities of waveforms, as discussed above. By using the stacked waveforms, the waveforms oriented to a fixed borehole azimuth is obtained by using the quadratic interpolation (or Lagrange polynomials).

In accordance with at least one embodiment of the present disclosure, the azimuth of the waveform may be determined using a trigonometric addition theorem. For example, after obtaining migration images for the measurement depth and fixed borehole azimuths, reflectors may be picked and azimuths computed. Suppose fᵢ (x, z) is the migration image of the ith azimuth (1≤i≤N), and two images which are apart 180° are summed as:

$${F}_{i} ( x , z ) = {f}_{i} ( x , z ) + {f}_{i + N / 2} ( x , z ) \qquad Eq . 15$$

where 1≤i≤N/2. Envelopes of fᵢ (x, z) and Fᵢ (x,z) are denoted by eᵢ(x, z) and Eᵢ(x, z), respectively. The azimuth of the reflector is estimated using the envelope of migration image Eᵢ(x, dᵢ(x)), where i is the azimuth index of reflector, x is the horizontal offset, and dᵢ (x) is the reflector depth along the offset. The reflectors are picked in each azimuth, and when Eᵢ(x, dᵢ (x))>Eᵢ₋₁ (x, dᵢ (x)) and Eᵢ(x, dᵢ (x))>Eᵢ₊₁ (x, dᵢ (x)) hold, dᵢ (x) in the ith azimuth is selected. The amplitudes of the signals in each azimuth are given by a cosine function of the angular difference between the incident angle and orientation angle of the receivers (as illustrated in FIG. 3-3). The relations between the azimuth and amplitudes may be given by

$${E}_{i - 1} ( x , {d}_{i} ( x ) ) = A cos ( δ θ - Δθ ) \qquad Eq . 16$$

$${E}_{i} ( x , {d}_{i} ( x ) ) = A cos ( δ θ ) \qquad Eq . 17$$

$${E}_{i + 1} ( x , {d}_{i} ( x ) ) = A cos ( δ θ + Δ θ ) \qquad Eq . 18$$

where A is the amplitudes of the signal, and δθ is the azimuth difference from the reflector azimuth to the ith azimuth. By using the trigonometric addition theorem, δθ may be given by:

$$δ θ ( x , {d}_{i} ( x ) ) = {tan}^{- 1} \frac{{E}_{i - 1} ( x , {d}_{i} ( x ) ) - {E}_{i + 1} ( x , {d}_{i} ( x ) )}{2 sin ( Δ θ ) {E}_{i} ( x , {d}_{i} ( x ) )} \qquad Eq . 19$$

Using the above equations, the reflector azimuth may be given by:

$$θ = ( i - 1 ) Δ θ - δ θ \qquad Eq . 20$$

where Δθ is the azimuth interval of migration image and the azimuth contains a 180° ambiguity. The average of δθ(x, dᵢ (x)) along the reflector may be computed to increase the stability of the estimated reflector angle.
In some embodiments, the resolution of the resulting image may be improved through resolution the 180° reflector azimuth. For example, suppose ith azimuth is the closest to θ given by equation 20, envelopes of reflectors in the two azimuthal images which are apart by 180° may be summed along the reflector according to:

$${\overline{e}}_{i} {\int }_{{x}_{1}}^{{x}_{2}} {e}_{i} ( x , {d}_{i} ( x ) ) dx \qquad Eq . 21$$

$${\overline{e}}_{i + \frac{N}{2}} {\int }_{{x}_{1}}^{{x}_{2}} {e}_{i + \frac{N}{2}} ( x , {d}_{i} ( x ) ) dx \qquad Eq . 22$$

where d (x) is the depth of reflector in [x1, x2]. The azimuth i and i+N/2 are selected for

$${\overline{e}}_{i} > {\overline{e}}_{i + \frac{N}{2}} and {\overline{e}}_{i} > {\overline{e}}_{i + \frac{N}{2}} ,$$

respectively. The index of the selected azimuth is denoted by j. The waveforms are stacked in [x1, x2] as

$${G}_{i} ( z ) = \frac{d}{dz} {\int }_{{x}_{1}}^{{x}_{2}} {F}_{i} ( x , z - {d}_{i} ( x ) ) dx \qquad Eq . 23$$

$${g}_{i} ( z ) = \frac{d}{dz} {\int }_{{x}_{1}}^{{x}_{2}} {f}_{j} ( x , z - {d}_{i} ( x ) ) dx \qquad Eq . 24$$

where the first-order derivative is applied to improve the resolution of cross correlation. Cross correlation may be computed as

$$c ( z ) = \frac{{\int }_{- L}^{L} {G}_{i} ( ζ ) {g}_{j} ( z + ζ ) d ζ}{{[ {\int }_{- L}^{L} {G}_{i}^{2} ( ζ ) d ζ {\int }_{- L}^{L} {g}_{j}^{2} ( z + ζ ) d ζ ]}^{\frac{1}{2}}} \qquad Eq . 25$$

where L is the window length, and may be provided by L=v/(2fc), where v is the signal velocity, and fc is the central frequency of the source. Gᵢ (z) and gj(z) may be resampled to obtain small depth differences. The maximum value of c (z) may be computed as:

$${c}_{m ax} = {max}_{- l < z < l} c ( z ) \qquad Eq . 26$$

where l is the window length. In some embodiments, the window length may be 0.05 L. Suppose z′ is z providing cmax. Then, z′<0 and z′>0 indicate z=di (x) in the ith azimuth is farther and closer to the well, respectively. For z′<0 and z′>0, azimuth 0 and 0+x is selected, respectively. When z′=0 holds, a 180° ambiguity is not resolved. The method described above has similar applicability when replacing Gi (z) with gj+N/2 (z).

In some embodiments, the reflectors may be highlighted to the appropriate positions by applying a weighting mask. The weighting mask may be multiplied to migration images, m (x, z). The weighting mask may be created as below to highlight reflectors at correct positions. Three distance parameters may defined as:

$${R}_{1} = {c}_{1} \frac{v}{{f}_{c}} \qquad Eq . 27$$

$${R}_{2} = {c}_{2} {R}_{1} \qquad Eq . 28$$

$${R}_{3} = {R}_{1} + {R}_{2} \qquad Eq . 29$$

where c1 and c2 are parameters, which are typically c1=1 and c2=1. The weighting mask m (x, z) may be initialized by zero at first, and the following computation may be sequentially applied to all picked points on reflectors. The distance from a picked point (xo, zo) may be computed as:

$$r = {[ {( x - {x}_{0} )}^{2} + {( z - {z}_{0} )}^{2} ]}^{\frac{1}{2}} \qquad Eq . 30$$

The weight function for (x, z) may be computed as:

$$w ( x , z ) = \{ \begin{matrix}1 , r \leq {R}_{1} , \\ \frac{1}{2} ( 1 + cos \frac{r - {R}_{1}}{{R}_{2}} π ) , {R}_{1} < r < {R}_{3} \\ 0 , r \leq {R}_{3}\end{matrix} \qquad Eq . 31$$

The weighting mask is computed as:

$$m ( x , z ) = max ( w ( x , z ) , m ( x , z ) ) \qquad Eq . 32$$

m (x, z) may be multiplied to the migration image as:

$${f}_{i}^{′} ( x , z ) = {m}_{i} ( x , z ) {f}_{i} ( x , z ) \qquad Eq . 33$$

After highlighting, the image may be adjusted to the Earth coordinates.

In some embodiments, the azimuth of the reflector from the well may be determined using the amplitudes of the waveforms or migration images. For the combined X- and Y-dipole waveforms, adjustments may be made because of the polarity adjustments. The angles used or calculated below may be adjusted so that 0≤θ<2π.

Suppose θ_{α} is the borehole azimuth that provides the maximum amplitude. The relative angle for the relative bearing may be defined as:

$${θ}_{a}^{′} = {θ}_{a} - {θ}_{r b} \qquad Eq . 34$$

The following indices may be defined to identify the tool azimuth for the borehole azimuth as:

$$I = ⌊ \frac{2 {θ}_{a}^{′}}{π} ⌋ \qquad Eq . 35$$

$$J = ⌊ \frac{2 ( {θ}_{a}^{′} - Δ θ )}{π} ⌋ \qquad Eq . 36$$

$$K = ⌊ \frac{2 ( {θ}_{a}^{′} + Δ θ )}{π} ⌋ \qquad Eq . 37$$

where Δθ is the sampling interval of the waveforms for the borehole azimuth. Suppose a₀, a₁, and a₂ are the amplitudes at θₐ−Δθ, θₐ, and θₐ+Δθ, respectively, the following equations are considered:

$$A cos ( δ θ - Δ θ ) = {a}_{0} \qquad Eq . 38$$

$$A cos ( δθ ) = {a}_{1} \qquad Eq . 39$$

$$A cos ( δθ + Δ θ ) = {a}_{2} \qquad Eq . 40$$

where A and δθ are the amplitude of reflected signal and azimuth shift of Og from the azimuth of the maximum amplitude, respectively.
Equations 38-40 may be solved by using the trigonometric addition theorem. For the I=J=K case, if a₀>a₂ Eq. 38 and 39 may be solved as Eq. 41:

$$δ θ = {sin}^{- 1} ( \frac{{a}_{0} - {a}_{1} cos Δ θ}{\sqrt{{( {a}_{0} - {a}_{1} cos Δ θ )}^{2} + {a}_{1}^{2} {sin}^{2} Δ θ}} ) \qquad Eq . 41$$

If a₀≤a₂ Eq. 39 and 40 may be solved as Eq. 42:

$$δ θ = {sin}^{- 1} ( \frac{{a}_{0} cos Δ θ - {a}_{2}}{\sqrt{{( {a}_{1} cos Δ θ - {a}_{0} )}^{2} + {a}_{1}^{2} {sin}^{2} Δ θ}} ) \qquad Eq . 42$$

For I=J and I≠K, and I=K and I≠J cases, Eq. 41 and Eq. 42 may be used, respectively. The azimuth of the reflector from the borehole may be given by θₐ−δθj. A may be solved by substituting δθ into Eq. 39.

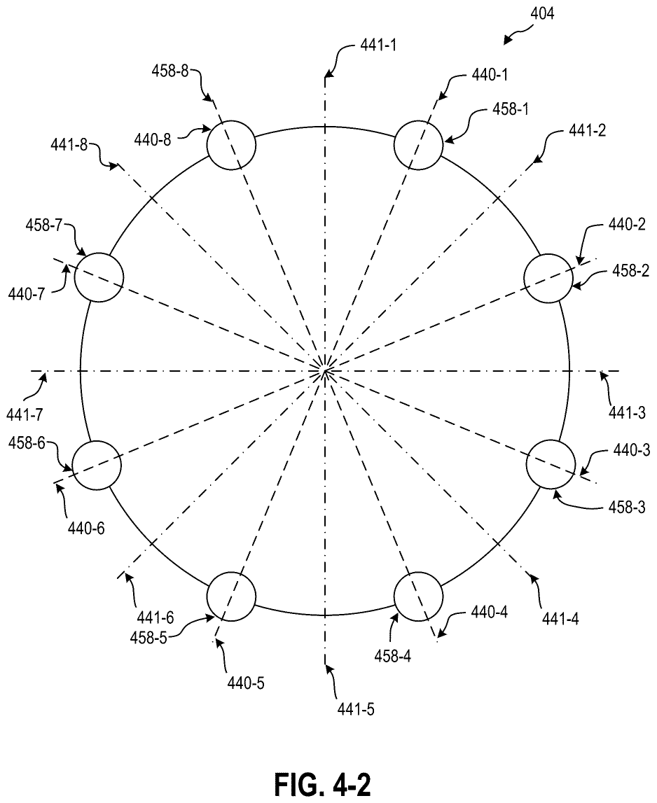

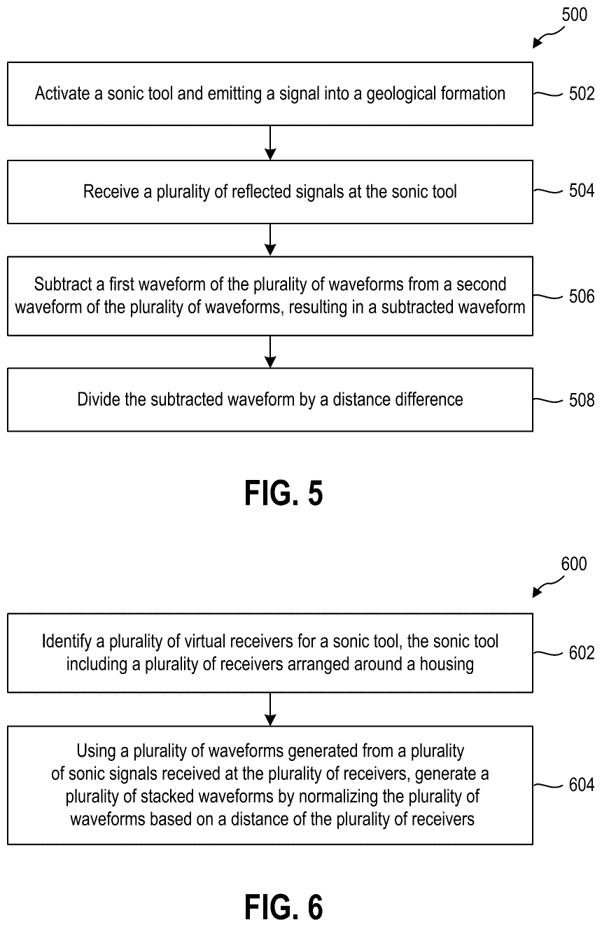

FIG. 5 and FIG. 6, the corresponding text, and the examples provide a number of different methods, systems, devices, and computer-readable media of the sonic signal processing system. In addition to the foregoing, one or more embodiments can also be described in terms of flowcharts comprising acts for accomplishing a particular result, as shown in FIG. 5 and FIG. 6. FIG. 5 and FIG. 6 may be performed with more or fewer acts. Further, the acts may be performed in differing orders. Additionally, the acts described herein may be repeated or performed in parallel with one another or parallel with different instances of the same or similar acts.

As mentioned, FIG. 5 illustrates a flowchart of a series of acts or a method 500 for normalizing a waveform for a sonic signal at a virtual receiver, according to at least one embodiment of the present disclosure. While FIG. 5 illustrates acts according to one embodiment, alternative embodiments may omit, add to, reorder, and/or modify any of the acts shown in FIG. 5. The acts of FIG. 5 can be performed as part of a method. Alternatively, a computer-readable medium can comprise instructions that, when executed by one or more processors, cause a computing device to perform the acts of FIG. 5. In some embodiments, a system can perform the acts of FIG. 5.

A sonic signal processing system may activate a sonic tool and emit a signal into a geological formation at 502. The sonic signal processing system may receive a plurality of reflected signals at the sonic tool at 504. Each of the plurality of reflected signals is received at a respective receiver of a plurality of receivers on the sonic tool. Each of the plurality of reflected signals has an associated waveform of a plurality of waveforms. The sonic signal processing system generates a plurality of stacked waveforms. Each stacked waveform of the plurality of stacked waveforms is associated with a virtual receiver of a plurality of virtual receivers.

In some embodiments, generating each stacked waveform of the plurality of stacked waveforms includes subtracting a first waveform of the plurality of waveforms from a second waveform of the plurality of waveforms, resulting in a subtracted waveform at 506. The first waveform is associated with a first receiver of the plurality of receivers and the second waveform is associated with a second receiver of the plurality of receivers. Generating the stacked waveforms further includes dividing the subtracted waveform by a distance difference between a first distance for the first receiver and a second distance for the second receiver at 508.

In some embodiments, at least one of the plurality of virtual receivers is located between adjacent receivers of the plurality of receivers. In some embodiments, at least one of the plurality of virtual receivers is coincident with at least one of the plurality of receivers. In some embodiments, the first receiver is adjacent the second receiver. In some embodiments, a third receiver of the plurality of receivers is located between the first receiver and the second receiver.

In some embodiments, the subtracted waveform includes a first subtracted waveform and the distance difference is a first distance difference. Dividing the first subtracted waveform from the first distance difference may result in a first stacked waveform part, and wherein generating each stacked waveform of the plurality of stacked waveforms further includes subtracting a third waveform of the plurality of waveforms from a fourth waveform of the plurality of waveforms, resulting in a second subtracted waveform. The third waveform is associated with a third receiver of the plurality of receivers and the fourth waveform is associated with a fourth receiver of the plurality of receivers. Generating the stacked waveforms may further include dividing the second subtracted waveform by a second distance difference between a third distance for the third receiver and a fourth distance for the fourth receiver, resulting in a second stacked waveform part. In some embodiments, generating the stacked waveforms may further include adding the first stacked waveform part and the second stacked waveform part. In some embodiments, the first receiver and the second receiver are located between the third receiver and the fourth receiver. In some embodiments, the third receiver and the fourth receiver are diametrically opposed.

In some embodiments, the distance difference includes an absolute value of the distance difference.

In some embodiments, generating each stacked waveform of the plurality of stacked waveforms further includes determining an azimuth of each stacked waveform using a trigonometric addition theorem.

In some embodiments, generating each stacked waveform of the plurality of stacked waveforms further includes combining an X-dipole component according to an X-directional sign function and a Y-dipole component according to a Y-directional sign function. In some embodiments, combining the X-dipole component and the Y-dipole component includes combining the X-dipole component and the Y-dipole component based on a relative bearing of the sonic tool.

As mentioned, FIG. 6 illustrates a flowchart of a series of acts or a method 600 for normalizing a waveform for a sonic signal at a virtual receiver, according to at least one embodiment of the present disclosure. While FIG. 6 illustrates acts according to one embodiment, alternative embodiments may omit, add to, reorder, and/or modify any of the acts shown in FIG. 6. The acts of FIG. 6 can be performed as part of a method. Alternatively, a computer-readable medium can comprise instructions that, when executed by one or more processors, cause a computing device to perform the acts of FIG. 6. In some embodiments, a system can perform the acts of FIG. 6.

In some embodiments, sonic signal processing system may identify a plurality of virtual receivers for a sonic tool at 602. The sonic tool includes a plurality of receivers arranged around a housing. The sonic signal processing system may, using a plurality of waveforms generated from a plurality of sonic signals received at the plurality of receivers, generate a plurality of stacked waveforms by normalizing the plurality of waveforms based on a distance of the plurality of receivers at 604. Each of the plurality of stacked waveforms is associated with an associated virtual receiver of the plurality of virtual receivers.

In some embodiments, generating the plurality of stacked waveforms includes generating the plurality of stacked waveforms at the sonic tool. In some embodiments, a virtual receiver quantity of the plurality of virtual receivers is double a receiver quantity of the plurality of receivers.

In some embodiments, normalizing the plurality of waveforms includes, for each of the plurality of waveforms, adding a first stacked waveform part to a second stacked waveform part. In some embodiments, the first stacked waveform part is normalized for a first receiver pair of the plurality of receivers and the second stacked waveform part is normalized for a second receiver pair of the plurality of receivers. In some embodiments, normalizing the plurality of waveforms includes dividing a subtracted waveform from a receiver distance.

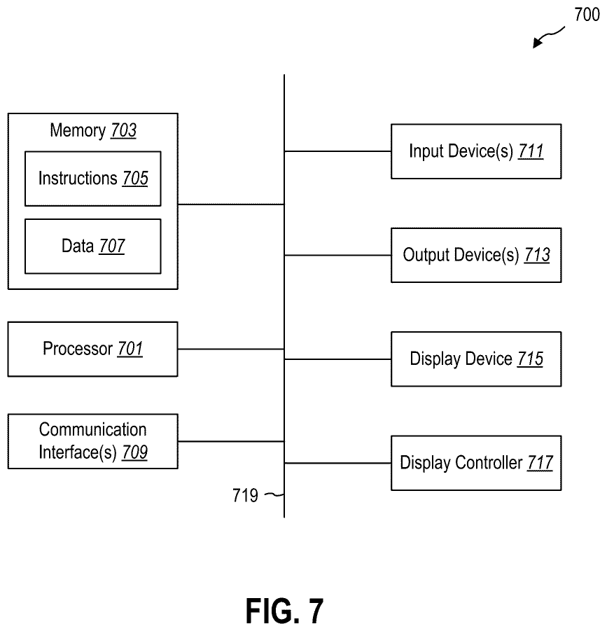

FIG. 7 illustrates certain components that may be included within a computer system 700. One or more computer systems 700 may be used to implement the various devices, components, and systems described herein.

The computer system 700 includes a processor 701. The processor 701 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 701 may be referred to as a central processing unit (CPU). Although just a single processor 701 is shown in the computer system 700 of FIG. 7, in an alternative configuration, a combination of processors (e.g., an ARM and DSP) could be used.

The computer system 700 also includes memory 703 in electronic communication with the processor 701. The memory 703 may be any electronic component capable of storing electronic information. For example, the memory 703 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 705 and data 707 may be stored in the memory 703. The instructions 705 may be executable by the processor 701 to implement some or all of the functionality disclosed herein. Executing the instructions 705 may involve the use of the data 707 that is stored in the memory 703. Any of the various examples of modules and components described herein may be implemented, partially or wholly, as instructions 705 stored in memory 703 and executed by the processor 701. Any of the various examples of data described herein may be among the data 707 that is stored in memory 703 and used during execution of the instructions 705 by the processor 701.

A computer system 700 may also include one or more communication interfaces 709 for communicating with other electronic devices. The communication interface(s) 709 may be based on wired communication technology, wireless communication technology, or both. Some examples of communication interfaces 709 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 700 may also include one or more input devices 711 and one or more output devices 713. Some examples of input devices 711 include a keyboard, mouse, microphone, remote control device, button, joystick, trackball, touchpad, and lightpen. Some examples of output devices 713 include a speaker and a printer. One specific type of output device that is typically included in a computer system 700 is a display device 715. Display devices 715 used with embodiments disclosed herein may utilize any suitable image projection technology, such as liquid crystal display (LCD), light-emitting diode (LED), gas plasma, electroluminescence, or the like. A display controller 717 may also be provided, for converting data 707 stored in the memory 703 into text, graphics, and/or moving images (as appropriate) shown on the display device 715.

The various components of the computer system 700 may be coupled together by one or more buses, which may include a power bus, a control signal bus, a status signal bus, a data bus, etc. For the sake of clarity, the various buses are illustrated in FIG. 7 as a bus system 719.

Examples in the present disclosure may also be directed to a non-transitory computer-readable medium storing computer-executable instructions and executable by one or more processors of the computer via which the computer-readable medium is accessed. A computer-readable media may be any available media that may be accessed by a computer. By way of example, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Note also that the software implemented aspects of the subject matter claimed below are usually encoded on some form of program storage medium or implemented over some type of transmission medium. The program storage medium is a non-transitory medium and may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The claimed subject matter is not limited by these aspects of any given implementation.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A method, comprising:
activating a sonic tool and emitting a signal into a geological formation;
receiving a plurality of reflected signals at the sonic tool, each of the plurality of reflected signals received at a respective receiver of a plurality of receivers on the sonic tool, each of the plurality of reflected signals having an associated waveform of a plurality of waveforms; and
generating a plurality of stacked waveforms, each stacked waveform of the plurality of stacked waveforms associated with a virtual receiver of a plurality of virtual receivers, wherein generating each stacked waveform of the plurality of stacked waveforms includes:
subtracting a first waveform of the plurality of waveforms from a second waveform of the plurality of waveforms, resulting in a subtracted waveform, wherein the first waveform is associated with a first receiver of the plurality of receivers and the second waveform is associated with a second receiver of the plurality of receivers; and
dividing the subtracted waveform by a distance difference between a first distance for the first receiver and a second distance for the second receiver.

2. The method of claim 1, wherein at least one of the plurality of virtual receivers is located between adjacent receivers of the plurality of receivers.

3. The method of claim 1, wherein at least one of the plurality of virtual receivers is coincident with at least one of the plurality of receivers.

4. The method of claim 1, wherein the distance difference includes an absolute value of the distance difference.

5. The method of claim 1, wherein the first receiver is adjacent the second receiver.

6. The method of claim 1, wherein a third receiver of the plurality of receivers is located between the first receiver and the second receiver.

7. The method of claim 1, wherein the subtracted waveform includes a first subtracted waveform and the distance difference is a first distance difference, and wherein dividing the first subtracted waveform from the first distance difference results in a first stacked waveform part, and wherein generating each stacked waveform of the plurality of stacked waveforms further includes:
subtracting a third waveform of the plurality of waveforms from a fourth waveform of the plurality of waveforms, resulting in a second subtracted waveform, wherein the third waveform is associated with a third receiver of the plurality of receivers and the fourth waveform is associated with a fourth receiver of the plurality of receivers;
dividing the second subtracted waveform by a second distance difference between a third distance for the third receiver and a fourth distance for the fourth receiver, resulting in a second stacked waveform part; and
adding the first stacked waveform part and the second stacked waveform part.

8. The method of claim 7, wherein the first receiver and the second receiver are located between the third receiver and the fourth receiver.

9. The method of claim 7, wherein the third receiver and the fourth receiver are diametrically opposed.

10. The method of claim 1, wherein generating each stacked waveform of the plurality of stacked waveforms further includes determining an azimuth of each stacked waveform using a trigonometric addition theorem.

11. The method of claim 1, wherein generating each stacked waveform of the plurality of stacked waveforms further includes combining an X-dipole component according to an X-directional sign function and a Y-dipole component according to a Y-directional sign function.

12. The method of claim 11, wherein combining the X-dipole component and the Y-dipole component includes combining the X-dipole component and the Y-dipole component based on a relative bearing of the sonic tool.

13. The method of claim 1, further comprising adjusting an operating setting of the sonic tool using the plurality of stacked waveforms.

14. A method, comprising:
identifying a plurality of virtual receivers for a sonic tool, the sonic tool including a plurality of receivers arranged around a housing; and
using a plurality of waveforms generated from a plurality of sonic signals received at the plurality of receivers, generating a plurality of stacked waveforms by normalizing the plurality of waveforms based on a distance of the plurality of receivers, each of the plurality of stacked waveforms associated with an associated virtual receiver of the plurality of virtual receivers.

15. The method of claim 14, wherein generating the plurality of stacked waveforms includes generating the plurality of stacked waveforms at the sonic tool.

16. The method of claim 14, wherein a virtual receiver quantity of the plurality of virtual receivers is double a receiver quantity of the plurality of receivers.

17. The method of claim 14, wherein normalizing the plurality of waveforms includes, for each of the plurality of waveforms, adding a first stacked waveform part to a second stacked waveform part.

18. The method of claim 17, wherein the first stacked waveform part is normalized for a first receiver pair of the plurality of receivers and the second stacked waveform part is normalized for a second receiver pair of the plurality of receivers.

19. The method of claim 14, normalizing the plurality of waveforms includes dividing a subtracted waveform from a receiver distance.

20. A system, comprising:
a processor and memory, the memory including instructions that cause the processor to:
activate a sonic tool and emitting a signal into a geological formation;
receive a plurality of reflected signals at the sonic tool, each of the plurality of reflected signals received at a respective receiver of a plurality of receivers on the sonic tool, each of the plurality of reflected signals having an associated waveform of a plurality of waveforms; and
generate a plurality of stacked waveforms, each stacked waveform of the plurality of stacked waveforms associated with a virtual receiver of a plurality of virtual receivers, wherein generating each stacked waveform of the plurality of stacked waveforms includes:
subtract a first waveform of the plurality of waveforms from a second waveform of the plurality of waveforms, resulting in a subtracted waveform, wherein the first waveform is associated with a first receiver of the plurality of receivers and the second waveform is associated with a second receiver of the plurality of receivers; and
divide the subtracted waveform by a distance difference between a first distance for the first receiver and a second distance for the second receiver.
